(19) United States
(12) Patent Application Publication
(10) Pub. No.: US 2006/0252446 A1
(43) Pub. Date: Nov. 9, 2006

(54) Method and apparatus for setting a power limit for high speed downlink packet access services

(75) Inventor: Guodong Zhang, Farmingdale, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/153,208

(22) Filed: Jun. 15, 2005

Related U.S. Application Data
(60) Provisional application No. 60/678,648, filed on May 6, 2005.

(51) Int. Cl. H04B 7/00; H04Q 7/20

(52) U.S. Cl. 455/522

(57) ABSTRACT

The present invention is related to a method and apparatus for setting a power limit for high speed downlink packet access (HSDPA) services. In a wireless communication system comprising a plurality of cells, each cell supports transmissions via at least a dedicated channel (DCH) and a HSDPA channel and is subject to a maximum downlink transmission power limit. In accordance with one embodiment, a radio network controller (RNC) estimates a ratio between the average total downlink transmission power level used by DCHs and the average total downlink transmission power level used by HSDPA services in each cell and sets the maximum HSDPA transmission power limit based on the estimated ratio. In accordance with another embodiment, the RNC estimates an average total power consumed by DCHs in the cell and sets the maximum HSDPA transmission power limit by subtracting the average total power consumed by DCHs from the maximum downlink transmission power level of the cell.

### CROSS REFERENCE TO RELATED APPLICATION

This application claims the benefit of U.S. Provisional Application No. 60/678,648 filed May 6, 2005, which is incorporated by reference as if fully set forth.

### FIELD OF INVENTION

The present invention is related to wireless communication systems. More particularly, the present invention is related to a method and apparatus for setting a power limit for high speed downlink packet access (HSDPA) services.

### BACKGROUND

In a universal mobile telecommunication system (UMTS), HSDPA is implemented for high speed data transmissions. With HSDPA services, data is buffered and scheduled for transmission by a Node-B. Since the Node-B can make decisions and manage downlink radio resources on a short-term basis more efficiently than a radio network controller (RNC), the Node-B is responsible for scheduling transmission of data packets to wireless transmit/receive units (WTRUs). However, the RNC still retains coarse overall control of the Node-Bs so that the RNC can perform functions such as call admission control and congestion control.

In order to retain the coarse overall control of the cells, the RNC needs to limit the effect of scheduling of HSDPA by the Node-B within a predetermined range. Therefore, it is desirable to provide a method for controlling the total power that can be used for a high speed downlink shared channel (HS-DSCH) in the cells.

### SUMMARY

The present invention is related to a method and apparatus for setting a power limit for HSDPA services. In a wireless communication system comprising a plurality of cells, each cell supports transmissions via a dedicated channel (DCH) and an HSDPA channel and is subject to a maximum downlink transmission power limit. In accordance with one embodiment, an RNC estimates a ratio between the average total downlink transmission power level used by DCHs and the average total downlink transmission power level used by HSDPA channels in each cell and sets the maximum HSDPA transmission power limit based on the estimated ratio. In accordance with another embodiment, the RNC estimates an average total power consumed by DCHs in the cell and sets the maximum HSDPA transmission power limit of the cell by subtracting the average total power consumed by DCHs from the maximum downlink transmission power level of the cell.

### BRIEF DESCRIPTION OF THE DRAWINGS

FIG. 1 is a block diagram of a wireless communication system.

FIG. 2 is a flow diagram of a process for setting a maximum transmission power limit for HSDPA services in a cell in accordance with one embodiment of the present invention.

FIG. 3 is a flow diagram of a process for setting a maximum transmission power limit for HSDPA services in a cell in accordance with another embodiment of the present invention.

FIG. 4 is a block diagram of an RNC in accordance with the present invention.

### DETAILED DESCRIPTION OF THE PREFERRED EMBODIMENTS

Hereafter, the terminology “WTRU” includes but is not limited to a user equipment, a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

The features of the present invention may be incorporated into an integrated circuit (IC) or be configured in a circuit comprising a multitude of interconnecting components.

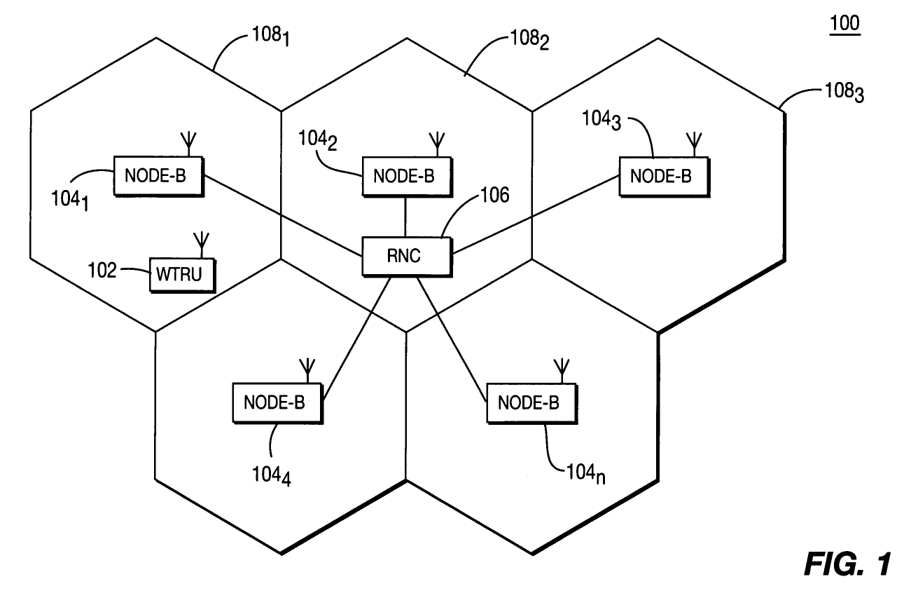

FIG. 1 is a block diagram of a wireless communication system 100. The wireless communication system comprises a plurality of cells 108₁-108ₙ. WTRUs 102 are served by a Node-B 104₁-104ₙ in each cell 108₁-108ₙ and the Node-Bs 104₁-104ₙ are controlled by an RNC 106. The wireless communication system 100 is configured to provide both regular DCH services and HSDPA services. The RNC 106 sets a maximum allowable transmit power for downlink transmissions of each Node-B 104₁-104ₙ and a maximum allowable transmit power for HS-DSCH transmissions.

FIG. 4 is a block diagram of an RNC 106 in accordance with the present invention. The RNC 106 comprises an estimator 110 and a HSDPA configuration unit 112. Of course, those of skill in the art would realize that there are many other components in a typical RNC. However, only those components that are specifically relevant to the RNC 106 of the present invention have been shown in FIG. 4. In accordance with one embodiment, the estimator 110 estimates a ratio between total downlink transmission power level used by DCH transmissions and total downlink transmission power level used for HS-DSCH transmissions, and the HSDPA configuration unit 112 sets the maximum transmission power limit for the HS-DSCH transmissions based on the estimated ratio. In accordance with another embodiment, the estimator 110 estimates an average total power consumed by DCHs in the cell and the HSDPA configuration unit 112 sets the maximum transmission power limit for the HS-DSCH transmissions of the cell by subtracting the average total power consumed by DCHs from the maximum downlink transmission power level of the cell.

With a proper power setting for HS-DSCH transmissions, the RNC 106 can keep coarse overall control of the cells and the cell resources can be utilized more efficiently for both regular DCHs and HS-DSCHs.

In accordance with the present invention, the total power setting for all HS-DSCHs is determined by taking the following factors into consideration:
Expected load of regular DCH traffic, which is preferably determined by:
   a required energy per bit to noise ratio;
   a data rate; and
   an activity factor. Activity factor is a term, well known to those skilled in the art that the ratio of actual channel utilization in time of a service type. For example, the activity factor of voice service is about 40%, which means the channel is actually occupied 40% of the time by the voice user.
Expected load of HSDPA traffic, which is preferably determined by:
   possible modulation and coding schemes (MCS) and average probability that each MCS is applied;
   a required energy per bit to noise ratio of each MCS;
   a data rate of each MCS; and
   an activity factor.
Maximum transmit power of the Node-B (or associated base station) in the downlink.
The fact that the total power used by regular DCHs is not limited, but only the total power used by HS-DSCHs is limited. That is, sometimes the power left for HS-DSCHs after downlink transmit power for regular DCHs are allocated may be less than the limit set by the RNC.

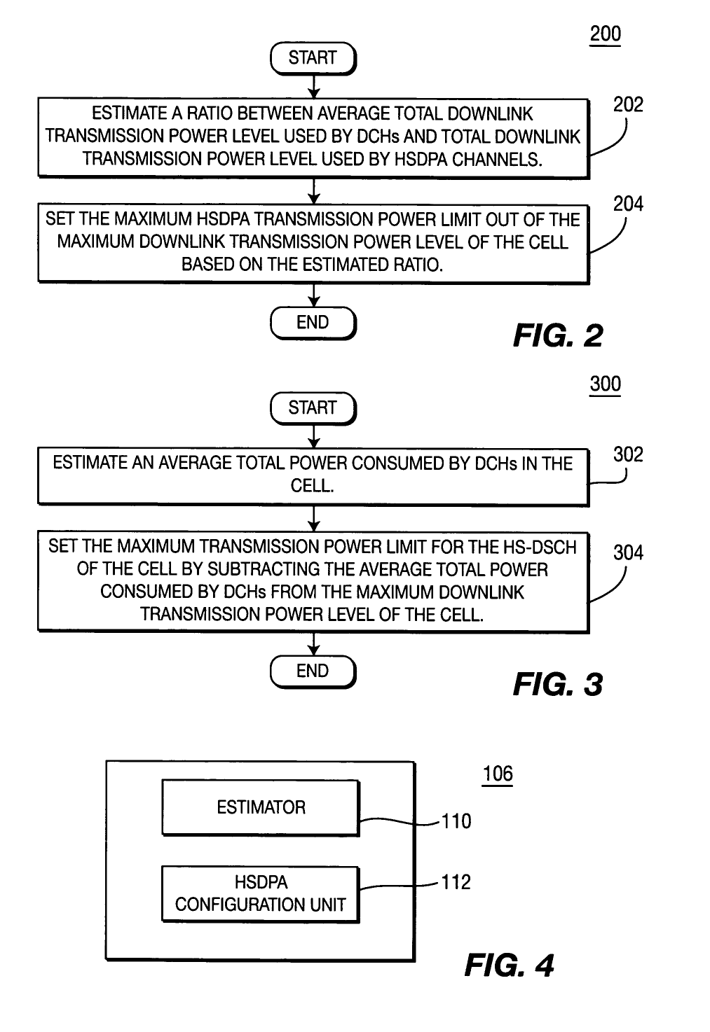

FIG. 2 is a flow diagram of a process 200 for setting a maximum transmission power limit for HSDPA services in a cell in accordance with one embodiment of the present invention. The estimator 110 of the RNC 106 estimates a ratio between total downlink transmission power level used by DCHs and total downlink transmission power level used by HSDPA channels in each cell (step 202). The HSDPA configuration unit 112 of the RNC 106 sets the maximum HSDPA transmission power limit out of the maximum downlink transmission power level of the cell based on the estimated ratio (step 204).

The algorithm for setting the transmit power limit for HSDPA services is explained in detail hereinafter. Suppose that there are N users with regular DCH services in a frequency division duplex (FDD) system, the average downlink transmit power of user i is defined as follows:

$$\overline{{Power}_{DL} ( i )} = \frac{{N}_{0} \cdot W \cdot \overline{PL} \cdot {v}_{i} \cdot \frac{{( {E}_{b} / {N}_{0} )}_{i} \cdot {R}_{i}}{W}}{( 1 - α + \overline{{η}_{dl}} ) \cdot ( 1 - {\sum }_{i = 1}^{N} {v}_{i} \cdot \frac{{( {E}_{b} / {N}_{0} )}_{i} \cdot {R}_{i}}{W} )} ; \qquad Equation ( 1 )$$

where W is the chip rate, \overline{PL} is the average downlink path loss, N₀ is the background noise, Rᵢ is the data rate of user i, (E_{b}/N₀)ᵢ is the required energy per bit to noise ratio, vᵢ is the activity factor of user i, α is the average orthogonality between downlink codes, and \overline{η_{dl}} is the average inter-to-intra cell interference ratio in the downlink.

In accordance with equation (1), the ratio between average downlink transmit power of two users i and j (of different services) is given by:

$$\frac{\overline{{Power}_{DL} ( i )}}{\overline{{Power}_{DL} ( j )}} = \frac{{v}_{i} \cdot {( {E}_{b} / {N}_{0} )}_{i} \cdot {R}_{i}}{{v}_{j} \cdot {( {E}_{b} / {N}_{0} )}_{j} \cdot {R}_{j}} . \qquad Equation ( 2 )$$

In the case of both regular DCH and HSDPA services in the UMTS-FDD systems, based on the statistics of traffic in the cell, it is known that there are N_{DCH} regular DCH users and N_{HSDPA} HSDPA users in the cell on average. Assume that there are K possible modulation and coding schemes (MCSs), (denoted by 1, 2, . . . , K), for HSDPA services. Let R_{i,k} denotes the data rate of user i when MCS k is used, and (E_{b}/N₀)_{i,k} denotes the required energy per bit to noise ratio of user i when MCS k is used. The probability that a MCS k is applied for HSDPA is denoted by P(k). The value of P(k) depends on the characteristics of the radio channel.

The average required energy per bit to noise ratio of user i with HSDPA services is defined as follows:

$$\overline{{( {E}_{b} / {N}_{0} )}_{i}} = {\sum }_{k = 1}^{K} P ( k ) \cdot {( {E}_{b} / {N}_{0} )}_{i , k} ; \qquad Equation ( 3 )$$

and the average data rate of user i with HSDPA services is defined as follows:

$$\overline{{R}_{i}} = {\sum }_{k = 1}^{K} P ( k ) \cdot {R}_{i , k} . \qquad Equation ( 4 )$$

Based on Equation 2, the ratio between the average total power used by regular DCHs and the average total power used by HSDPA services is derived as follows:

$$\frac{\overline{{Power}_{DCH}}}{\overline{{Power}_{HSDPA}}} = \frac{{\sum }_{i = 1}^{{N}_{DCH}} {v}_{i} \cdot {( {E}_{b} / {N}_{0} )}_{i} \cdot {R}_{i}}{{\sum }_{j = 1}^{{N}_{HSDPA}} {v}_{j} \cdot \overline{{( {E}_{b} / {N}_{0} )}_{j}} \cdot \overline{{R}_{j}}} . \qquad Equation ( 5 )$$

It is preferable to set the limit of total transmit power that can be used by all HS-DSCHs, denoted by Powerₘₐₓ_{_{—}}_{HSDPA}, according to the ratio in equation (5). The maximum allowable transmit power of the Node-B in the downlink is Pₘₐₓ_{_{—}}_{BS}. Then, Powerₘₐₓ_{_{—}}_{HSDPA} is given by:

$$\begin{matrix}{Power}_{max\_ HSDPA} = \frac{\overline{{Power}_{HSDPA}}}{\overline{{Power}_{HSDPA}} + \overline{{Power}_{DCH}}} \cdot {P}_{max\_ BS} \\ = \frac{{\sum }_{j = 1}^{{N}_{HSDPA}} {v}_{j} \cdot \overline{{( {E}_{b} / {N}_{0} )}_{j}} \cdot \overline{{R}_{j}}}{{\sum }_{j = 1}^{{N}_{HSDPA}} {v}_{j} \cdot \overline{{( {E}_{b} / {N}_{0} )}_{j}} \cdot \overline{{R}_{j}} + {\sum }_{i = 1}^{{N}_{DCH}} {v}_{i} \cdot {( {E}_{b} / {N}_{0} )}_{i} \cdot {R}_{i}} \cdot \\ = {P}_{max\_ BS} .\end{matrix} \qquad Equation ( 6 )$$

Given that the total downlink transmit power used for regular DCHs is not limited, but only the total downlink transmit power used for HS-DSCHs is limited, (which means regular DCHs have preemptive priorities over HS-DSCHs in power usage), a margin is preferably applied to the transmit power limit for HSDPA services obtained in Equation (6). Therefore, the maximum power limit for HSDPA services is given by:

$${Power}_{max\_ HSDPA} = ( \frac{{\sum }_{j = 1}^{{N}_{HSDPA}} {v}_{j} \cdot \overline{{( {E}_{b} / {N}_{0} )}_{j}} \cdot \overline{{R}_{j}}}{\begin{matrix}{\sum }_{j = 1}^{{N}_{HSDPA}} {v}_{j} \cdot \overline{{( {E}_{b} / {N}_{0} )}_{j}} \cdot \overline{{R}_{j}} + \\ {\sum }_{i = 1}^{{N}_{DCH}} {v}_{i} \cdot {( {E}_{b} / {N}_{0} )}_{i} \cdot {R}_{i}\end{matrix}} \cdot {P}_{max\_ BS} ) \cdot M ; \qquad Equation ( 7 )$$

where M is the margin whose value is a design parameter.

FIG. 3 is a flow diagram of a process 300 for setting a maximum transmission power limit for HSDPA services in a cell in accordance with another embodiment of the present invention. The estimator 110 of the RNC 106 estimates an average total power consumed by DCHs in each cell (step 302). The HSDPA configuration unit 112 of the RNC 106 sets the maximum HSDPA transmission power limit of the cell by subtracting the average total power consumed by DCHs from the maximum allowable downlink transmission power level of the cell (step 304).

The algorithm for setting the transmit power limit for HSDPA services is explained in detail hereinafter. Suppose that there are N users with regular DCH services in an FDD system (without considering HSDPA services), the average downlink transmit power of user i is defined as follows:

$$\overline{{Power}_{DL} ( i )} = \frac{{N}_{0} \cdot W \cdot \overline{PL} \cdot {v}_{i} \cdot \frac{{( {E}_{b} / {N}_{0} )}_{i} \cdot {R}_{i}}{W}}{( 1 - α + \overline{{η}_{dl}} ) \cdot ( 1 - {\sum }_{i = 1}^{N} {v}_{i} \cdot \frac{{( {E}_{b} / {N}_{0} )}_{i} \cdot {R}_{i}}{W} )} ; \qquad Equation ( 8 )$$

where W is the chip rate, \overline{PL} is the average downlink path loss, N₀ is the background noise, Rᵢ is the data rate of user i, (E_{b}/N₀)ᵢ is the required energy per bit to noise ratio, vᵢ is the activity factor of user i, α is the average orthogonality between downlink codes, and \overline{η_{dl}} is the average inter-to-intracell interference ratio in the downlink.

In cases when both regular DCH and HSDPA services are provided, based on the statistics of traffic in the cell, it is known that there are N_{DCH} regular DCH users and N_{HSDPA} HSDPA users in the cell on average. Assume that there are K possible MCSs for HSDPA services. R_{i,k} denotes the data rate of user i when MCS k is used, and (E_{b}/N₀)_{i,k} denotes the required energy per bit to noise ratio of user i when MCS k is used. The probability that MCS k is applied for HSDPA is denoted by P(k). The value of P(k) depends on the characteristics of the radio channel. The average required energy per bit to noise ratio of user i with HSDPA services is defined as follows:

$$\overline{{( {E}_{b} / {N}_{0} )}_{i}} = {\sum }_{k = 1}^{K} P ( k ) \cdot {( {E}_{b} / {N}_{0} )}_{i , k} ; \qquad Equation ( 9 )$$

and the average data rate of user i with HSDPA services is defined as follows:

$$\overline{{R}_{i}} = {\sum }_{k = 1}^{K} P ( k ) \cdot {R}_{i , k} . \qquad Equation ( 10 )$$

Thus, the average total transmit power consumed by regular DCHs is given by:

$$\overline{{Power}_{DCH}} = \frac{{N}_{0} \cdot W \cdot \overline{PL} \cdot {\sum }_{i = 1}^{{N}_{DCH}} {v}_{i} \cdot \frac{{( {E}_{b} / {N}_{0} )}_{i} \cdot {R}_{i}}{W}}{( 1 - α + \overline{{η}_{dl}} ) \cdot ( \begin{matrix}1 - {\sum }_{i = 1}^{{N}_{DCH}} {v}_{i} \cdot \frac{{( {E}_{b} / {N}_{0} )}_{i} \cdot {R}_{i}}{W} - \\ {\sum }_{i = 1}^{{N}_{HSDPA}} {v}_{i} \cdot \frac{\overline{{( {E}_{b} / {N}_{0} )}_{i}} \cdot \overline{{R}_{i}}}{W}\end{matrix} )} \qquad Equation ( 11 )$$

The maximum allowed transmit power of the base station in the downlink is Pₘₐₓ_{_{—}}_{BS}. Since regular DCHs have preemptive priorities over HSDPA in power usage, it is preferable to set the limit of total power that can be used by all HS-DSCHs, denoted by Powerₘₐₓ_{_{—}}_{HSDPA}, as follows:
Powerₘₐₓ_{_{—}}_{HSDPA}=Pₘₐₓ_{_{—}}_{BS}−\overline{Power_{DCH}}. Equation (12)

Optionally, a margin can be applied to the transmit power limit for HSDPA services obtained in equation (12).

The present invention is applicable to both UMTS-FDD systems and UMTS-time division duplex (TDD) systems. The downlink of UMTS-TDD system is similar to the UMTS-FDD system, except for the difference in the time slot structure and the multiuser detection (MUD) receiver. Therefore, the embodiment applied for the FDD system can be applied to the TDD system with the following two changes: First, the chip rate of the system in FDD systems, W, should be replaced by the equivalent chip rate in a time slot in TDD systems. Thus, if there are S time slots in TDD systems, the equivalent chip rate in a time slot is equal to W/S.

Second, the average orthogonality between downlink codes in FDD systems, α, should be replaced by the MUD efficiency factor, (percentage of intracell interference that can be cancelled), in the downlink of TDD systems.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system comprising a plurality of cells, each cell supporting transmissions via at least one dedicated channel (DCH) and at least one high speed downlink shared channel (HS-DSCH) and each cell being subject to a maximum downlink transmission power limit, a method for setting a maximum transmission power limit for HS-DSCH transmissions in a cell, the method comprising:
estimating a ratio between the average total downlink transmission power level used by DCHs and the average total downlink transmission power level used by HS-DSCHs; and
setting the maximum transmission power limit for the HS-DSCH transmissions based on the estimated ratio.

2. The method of claim 1 wherein DCH transmissions are provided priority over HS-DSCH transmissions in power usage.

3. The method of claim 2 wherein the maximum transmission power limit for HS-DSCH transmissions is further adjusted with a margin.

4. The method of claim 1 wherein the maximum transmission power limit for HS-DSCH transmissions is determined by considering at least one of expected load of DCH traffic, expected load of HSDPA traffic, maximum downlink transmit power in the cell, and applicability of preemption for DCHs over HSDPA channels.

5. The method of claim 4 wherein the expected load of DCH traffic is determined by considering at least one of a required energy per bit to noise ratio, a data rate and an activity factor.

6. The method of claim 4 wherein the expected load of HSDPA traffic is determined by considering at least one of possible modulation and coding schemes (MCS) and average probability that each MCS is applied, a required energy per bit to noise ratio of each MCS, a data rate of each MCS, and an activity factor.

7. In a wireless communication system comprising a plurality of cells, each cell supporting transmissions via at least one dedicated channel (DCH) and at least one high speed downlink shared channel (HS-DSCH) and each cell being subject to a maximum downlink transmission power limit, a method for setting a maximum transmission power limit for HS-DSCH transmissions in a cell, the method comprising:
estimating an average total power consumed by DCHs in the cell; and
setting the maximum transmission power limit for the HS-DSCH of the cell by subtracting the average total power consumed by DCHs from the maximum downlink transmission power level of the cell.

8. The method of claim 7 wherein DCH transmissions are provided priority over HS-DSCH transmissions in power usage.

9. The method of claim 8 wherein the maximum transmission power limit for HS-DSCH transmissions is further adjusted with a margin.

10. The method of claim 7 wherein the maximum transmission power limit for HS-DSCH transmissions is determined by considering at least one of expected load of DCH traffic, expected load of HSDPA traffic, maximum downlink transmit power in the cell, and applicability of preemption for DCHs over HSDPA channels.

11. The method of claim 10 wherein the expected load of DCH traffic is determined by considering at least one of a required energy per bit to noise ratio, a data rate and an activity factor.

12. The method of claim 10 wherein the expected load of HSDPA traffic is determined by considering at least one of possible modulation and coding schemes (MCS) and average probability that each MCS is applied, a required energy per bit to noise ratio of each MCS, a data rate of each MCS, and an activity factor.

13. In a wireless communication system comprising a plurality of cells, each cell supporting transmissions via at least one dedicated channel (DCH) and at least one high speed downlink shared channel (HS-DSCH) and each cell being subject to a maximum downlink transmission power limit, a radio network controller (RNC) for setting a maximum transmission power limit for the HS-DSCH transmissions in a cell, the RNC comprising:
an estimator for estimating a ratio between the average total downlink transmission power level used by DCH transmissions and the average total downlink transmission power level used for HS-DSCH transmissions; and
an HSDPA configuration unit for setting the maximum transmission power limit for the HS-DSCH transmissions based on the estimated ratio.

14. The RNC of claim 13 wherein DCH transmissions are provided priority over HS-DSCH transmissions in power usage.

15. The RNC of claim 14 wherein the maximum transmission power limit for HS-DSCH transmissions is further adjusted with a margin.

16. The RNC of claim 13 wherein the maximum transmission power limit for HS-DSCH transmissions is determined by considering at least one of expected load of DCH traffic, expected load of HSDPA traffic, maximum downlink transmit power in the cell, and applicability of preemption for DCHs over HSDPA channels.

17. The RNC of claim 16 wherein the expected load of DCH traffic is determined by considering at least one of a required energy per bit to noise ratio, a data rate and an activity factor.

18. The RNC of claim 16 wherein the expected load of HSDPA traffic is determined by considering at least one of possible modulation and coding schemes (MCS) and average probability that each MCS is applied, a required energy per bit to noise ratio of each MCS, a data rate of each MCS, and an activity factor.

19. In a wireless communication system comprising a plurality of cells, each cell supporting transmissions via at least one dedicated channel (DCH) and at least one high speed downlink shared channel (HS-DSCH) and each cell being subject to a maximum downlink transmission power limit, a radio network controller (RNC) for setting a maximum transmission power limit for HS-DSCH transmissions in a cell, the RNC comprising:
an estimator for estimating an average total power consumed by DCHs in the cell; and
an HSDPA configuration unit for setting the maximum transmission power limit for the HS-DSCH transmissions of the cell by subtracting the average total power consumed by DCHs from the maximum downlink transmission power level of the cell.

20. The RNC of claim 19 wherein DCH transmissions are provided priority over HS-DSCH transmissions in power usage.

21. The RNC of claim 20 wherein the maximum transmission power limit for HS-DSCH transmissions is further adjusted with a margin.

22. The RNC of claim 19 wherein the maximum transmission power limit for HS-DSCH transmissions is determined by considering at least one of expected load of DCH traffic, expected load of HSDPA traffic, maximum downlink transmit power in the cell, and applicability of preemption for DCHs over HSDPA channels.

23. The RNC of claim 22 wherein the expected load of DCH traffic is determined by considering at least one of a required energy per bit to noise ratio, a data rate and an activity factor.

24. The RNC of claim 22 wherein the expected load of HSDPA traffic is determined by considering at least one of possible modulation and coding schemes (MCS) and average probability that each MCS is applied, a required energy per bit to noise ratio of each MCS, a data rate of each MCS, and an activity factor.
